(19) United States
(12) Patent Application Publication
(10) Pub. No.: US 2015/0205542 A1
(43) Pub. Date: Jul. 23, 2015

(54) VIRTUAL MACHINE MIGRATION IN SHARED STORAGE ENVIRONMENT

(71) Applicant: VMware, Inc., Palo Alto, CA (US)

(72) Inventor: Jinto ANTONY, Bangalore (IN)

(73) Assignee: VMWARE, INC., Palo Alto, CA (US)

(21) Appl. No.: 14/161,018

(22) Filed: Jan. 22, 2014

(51) Int. Cl. G06F 3/06; G06F 9/455

(52) U.S. Cl. CPC G06F 3/0647; G06F 9/45558; G06F 3/0604; G06F 3/0667; G06F 3/0683; G06F 2009/4557; G06F 2003/0697

(57) ABSTRACT

A source virtual machine (VM) executing on a source host is migrated to a destination host using a shared storage system connected to both hosts. The source VM memory is iteratively copied to a memory file stored on the shared storage system and locked by the source host. When the destination host is able to lock the memory file, memory pages from the memory file are copied into VM memory of a destination VM, and access to virtual machine disk files are transferred to the destination host.

### BACKGROUND

In the world of virtualization infrastructure, the term, “live migration” refers to the migration of a virtual machine (VM) from a source host computer to a destination host computer. Each host computer is a physical machine that may reside in a common datacenter or distinct datacenters. On each host, virtualization software includes hardware resource management software, which allocates physical resources to running VMs on the host and emulation software which provide instances of virtual hardware devices, such as storage devices, network devices, etc., that are interacted with by the guest system software, i.e., the software executing “within” each VM. Virtualization software running on each host also cooperates to perform the live migration.

### SUMMARY

One or more embodiments disclosed herein provide a method for migrating a source virtual machine from a source host to a destination host. The method includes instantiating a destination virtual machine (VM) on a destination host corresponding to a source VM on a source host, and creating a memory file stored in a shared storage system accessible by the source host and the destination host, wherein the source host has a lock on the memory file. The method further includes copying source VM memory to the memory file using a storage interface of the source host while the source VM is in a powered-on state, and acquiring, by operation of the destination host, the lock on the memory file. The method includes, responsive to acquiring the lock on the memory file, copying data from the memory file into destination VM memory associated with the destination VM using a storage interface of the destination host. The method includes transferring access for a virtual machine disk file associated with the source VM and stored in the shared storage system from the source host to the destination host.

Further embodiments of the present disclosure include a non-transitory computer-readable storage medium that includes instructions that enable a processing unit to implement one or more of the methods set forth above or the functions of the computer system set forth above.

### BRIEF DESCRIPTION OF THE DRAWINGS

FIG. 1 is a block diagram that illustrates a virtualized computing system with which one or more embodiments of the present disclosure may be utilized.

FIG. 2 is a flow diagram that illustrates steps for a method of migrating virtual machines in a shared storage environment, according to an embodiment of the present disclosure.

FIG. 3 is a block diagram depicting operations for migrating a virtual machine from a source host to a destination host, according to one embodiment of the present disclosure.

### DETAILED DESCRIPTION

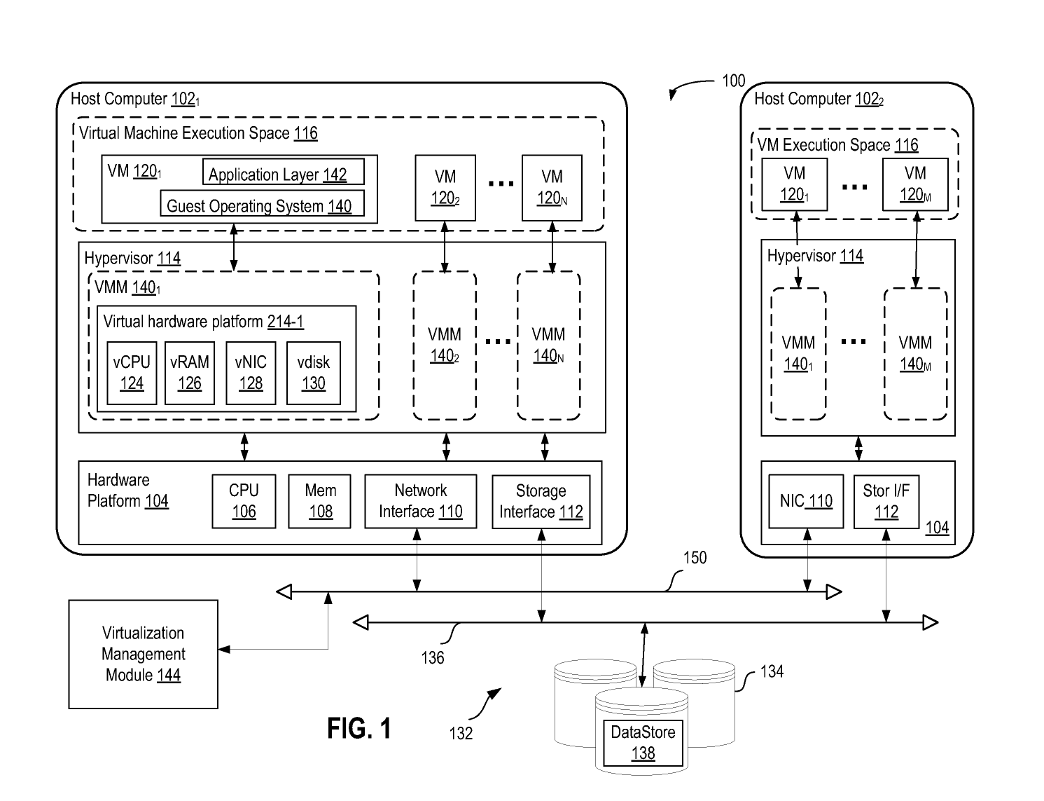

FIG. 1 depicts a block diagram of a virtualized computer system 100 in which one or more embodiments of the present disclosure may be practiced. The computer system 100 includes one or more host computer systems 102₁, 102₂, collectively identified as host computers 102. Host computer system 102 may be constructed on a desktop, laptop, or server grade hardware platform 104 such as an x86 architecture platform. As shown, hardware platform 104 of each host 102 may include conventional components of a computing device, such as one or more processors (CPUs) 106, system memory 108, a network interface 110, a storage interface 112, and other I/O devices such as, for example, a mouse and keyboard (not shown). Processor 106 is configured to execute instructions, for example, executable instructions that perform one or more operations described herein and may be stored in memory 108 and in local storage. Memory 108 is a device allowing information, such as executable instructions, cryptographic keys, virtual disks, configurations, and other data, to be stored and retrieved. Memory 108 may include, for example, one or more random access memory (RAM) modules. Network interface 110 enables host 102 to communicate with another device via a communication medium, such as network 150. An example of network interface 110 is a network adapter, also referred to as a Network Interface Card (NIC). In some embodiments, a plurality of NICs is included in network interface 110. Storage interface 112 enables host 102 to communicate with one or more network data storage systems that may, for example, store virtual disks that are accessed by virtual machines. Examples of storage interface 112 are a host bus adapter (HBA) that couples host 102 to a storage area network (SAN) or a network file system interface. In some embodiments, the storage interface 112 may be a network-enabled storage interface such as FibreChannel, and Internet Small Computer system Interface (iSCSI). By way of example, storage interface may be a FibreChannel host bus adapter (HBA) having a data transfer rate sufficient to transfer a complete execution state of a virtual machine, e.g., 4-Gbps, 8-Gbps, 16-Gbps FibreChannel HBAs.

In the embodiment shown, data storage for host computer 102 is served by a SAN 132, which includes a storage array 134 (e.g., a disk array), and a switch 136 that connects storage array 134 to host computer system 102 via storage interface 112. SAN 132 is accessible by both a first host 102₁ and a second host 102₂ (i.e., via respective storage interfaces 112), and as such, may be designated as a “shared storage” for hosts 102. In one embodiment, storage array 134 may include a datastore 138 configured for storing virtual machine files and other data that facilitates techniques for virtual machine migration, as described below. Switch 136, illustrated in the embodiment of FIG. 1, is a SAN fabric switch, but other types of switches may be used. In addition, distributed storage systems other than SAN, e.g., network attached storage, may be used.

A virtualization software layer, also referred to hereinafter as hypervisor 114, is installed on top of hardware platform 104. Hypervisor 114 supports a virtual machine execution space 116 within which multiple VM processes may be concurrently executed to instantiate VMs 120₁-120_{N}. For each of VMs 120₁-120_{N}, hypervisor 114 manages a corresponding virtual hardware platform 122 that includes emulated hardware such as a virtual CPU 124, virtual RAM 126 (interchangeably referred to as guest physical RAM or vRAM), virtual NIC 128, and one or more virtual disks or hard drive 130. For example, virtual hardware platform 122 may function as an equivalent of a standard x86 hardware architecture such that any x86 supported operating system, e.g., Microsoft Windows®, Linux®, Solaris® x86, NetWare, FreeBSD, etc., may be installed as a guest operating system 140 to execute any supported application in an application layer 142 for a VM 120. Device driver layers in guest operating system 140 of VM 120 includes device drivers (not shown) that interact with emulated devices in virtual hardware platform 122 as if such emulated devices were the actual physical devices. Hypervisor 114 is responsible for taking requests from such device drivers and translating the requests into corresponding requests for real device drivers in a device driver layer of hypervisor 114. The device drivers in device driver layer then communicate with real devices in hardware platform 104.

It should be recognized that the various terms, layers and categorizations used to describe the virtualization components in FIG. 1 may be referred to differently without departing from their functionality or the spirit or scope of the invention. For example, virtual hardware platforms 122 may be considered to be part of virtual machine monitors (VMM) 140₁-140_{N} which implement the virtual system support needed to coordinate operations between hypervisor 114 and their respective VMs. Alternatively, virtual hardware platforms 122 may also be considered to be separate from VMMs 140₁-140_{N}, and VMMs 140₁-140_{N} may be considered to be separate from hypervisor 114. One example of hypervisor 114 that may be used is included as a component of VMware's ESX™ product, which is commercially available from VMware, Inc. of Palo Alto, Calif. It should further be recognized that other virtualized computer systems are contemplated, such as hosted virtual machine systems, where the hypervisor is implemented in conjunction with a host operating system.

Computing system 100 may include a virtualization management module 144 that may communicate to the plurality of hosts 102 via a management network 150. In one embodiment, virtualization management module 144 is a computer program that resides and executes in a central server, which may reside in computing system 100, or alternatively, running as a VM in one of hosts 102. One example of a virtualization management module is the vCenter® Server product made available from VMware, Inc. Virtualization management module 144 is configured to carry out administrative tasks for the computing system 100, including managing hosts 102, managing VMs running within each host 102, provisioning VMs, migrating VMs from one host to another host, and load balancing between hosts 102.

In one or more embodiments, virtualization management module 144 is configured to migrate one or more VMs from one host to a different host, for example, from a first “source” host 102₁ to a second “destination” host 102₂. Virtualization management module 144 may perform a “live” migration of a virtual machine (i.e., with little to no downtime or perceivable impact to an end user) by transferring the entire execution state of the virtual machine, which includes virtual device state (e.g., state of the CPU 124, network and disk adapters), external connections with devices (e.g., networking and storage devices), and the virtual machine's physical memory (e.g., guest physical memory 126). Using conventional techniques for VM migration, a high-speed network is required to transfer the execution state of the virtual machine is transferred from a source host to a destination host. Without sufficient bandwidth in the high-speed network (i.e., enough network throughput such that the host can transfer memory pages over the high-speed network faster than the rate of dirtying memory pages), a VM migration is likely to fail. As such, conventional techniques for VM migration have called for the use of separate high-speed network hardware (e.g., 10-Gbps/1-Gbps NIC per host and a 10-Gpbs/1-Gpbs Ethernet switch) dedicated to VM migration. However, this additional hardware increases the costs for providing a virtualized infrastructure, and reduces resource efficiency, as the dedicated network hardware would go unused when not performing a migration). Even using a non-dedicated network, such as network 150, for live migration may be problematic, as bandwidth used to transfer the VM can deny network resources to other applications and workloads executing within the computing system.

Accordingly, embodiments of the present disclosure eliminate the need for a network for VM migration and instead utilizes shared storage to perform VM migration. In one or more embodiments, the execution state of a VM, including the memory state of the VM, is written to shared storage using a high-speed storage interface (e.g., storage interface 112) until all changes memory pages of a VM are updated, and then a virtual disk file handle is transferred to a destination host. In one or more embodiments, the execution state of the VM is transferred to a destination host via the shared storage system and without transferring any data representing the execution state of the VM over a network.

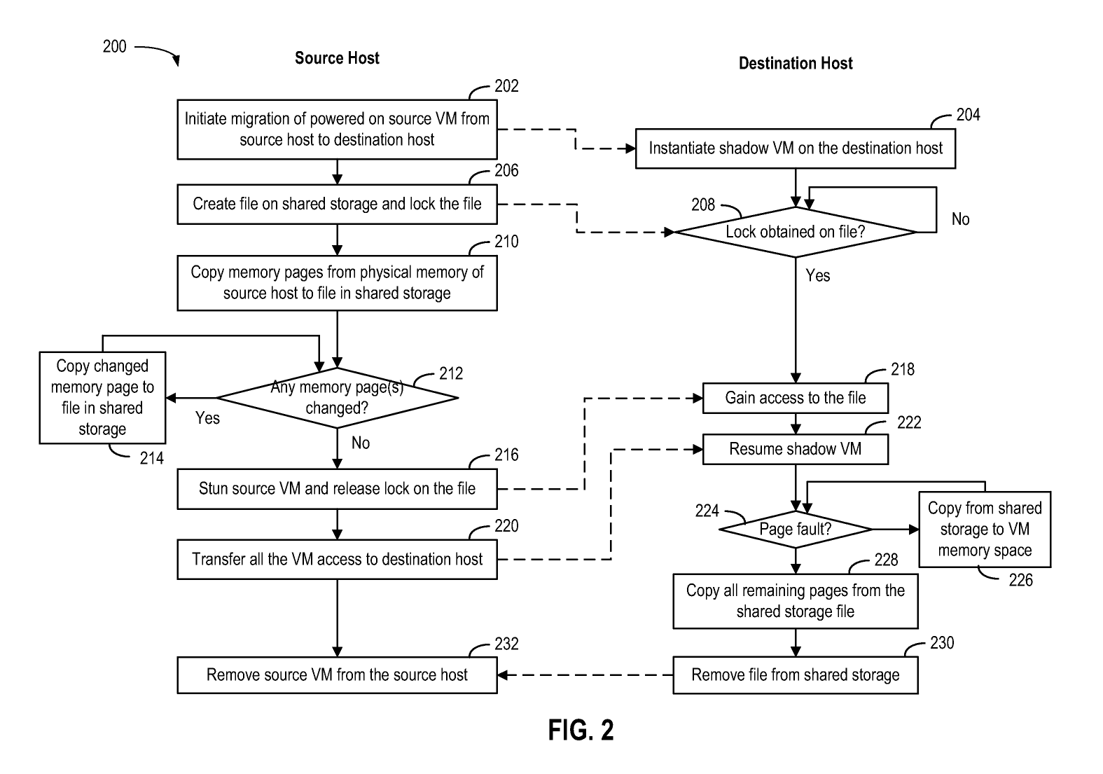

FIG. 2 is a flow diagram that illustrates steps for a method 200 of migrating a VM from one host to another host in a shared storage environment, according to an embodiment of the present disclosure. It should be recognized that, even though the method is described in conjunction with the system of FIG. 1, any system configured to perform the method steps is within the scope of embodiments of the disclosure. The method 200 will be described concurrently with FIG. 2, which is a block diagram depicting a system for migrating a VM from one host to another using shared storage, according to one embodiment of the present disclosure.

The method 200 begins at step 202, where virtualization management module 144 initiates a migration on a source host of a VM from the source host to a specified destination host. Virtualization management module 144 may communicate with a corresponding agent process executing on each of the hosts 102 to coordinate the migration procedure and instruct the source host and the destination host to perform each of the steps described herein.

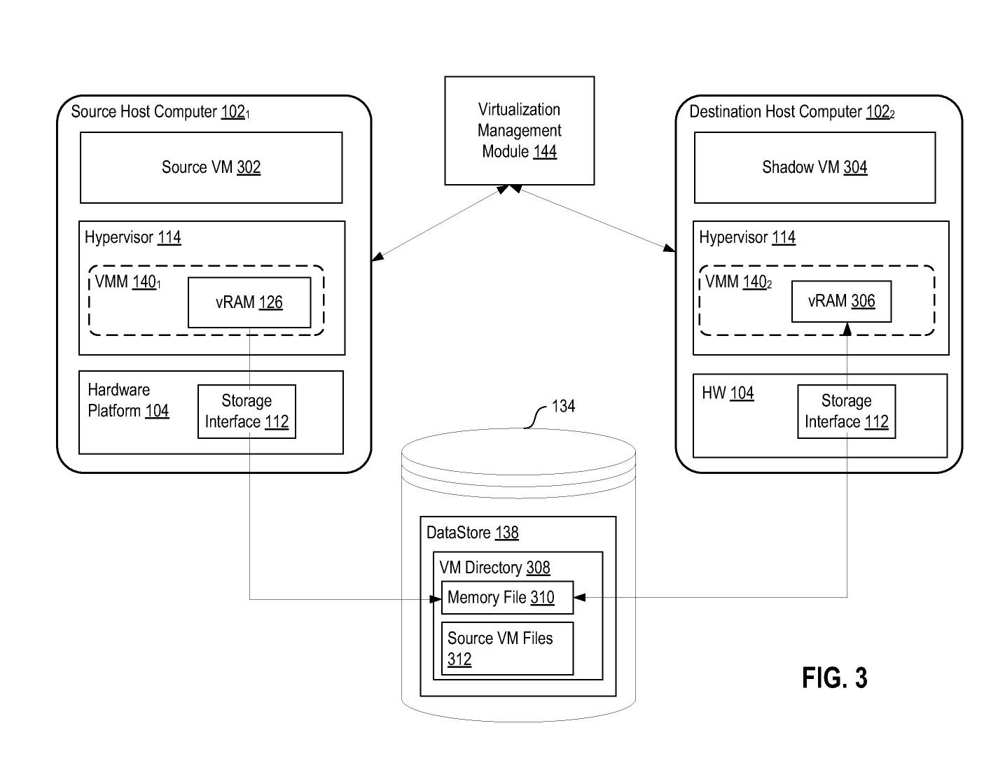

In the example shown in FIG. 3, virtualization management module 144 initiates a procedure to migrate a source VM 302, which is powered on and running, from a first host computer 102₁ to a second host computer 102₂. Both host computer 102₁ and second host computer 102₂ have access to a shared storage system, depicted as storage array 134, by respective storage interfaces 112 on each host. In one embodiment, source VM 302 may comprise one or more files 312 stored in a location within datastore 138, such as a directory 308 associated with that particular source VM. Source VM files 312 may include log files of the source VM's activity, VM-related configuration files (e.g., “.vmx” files), a paging file (e.g., “.vmem” files) which backs up source VM's memory on the host file system (i.e., in cases of memory over commitment), and one or more virtual disk files (e.g., VMDK files) that store the contents of source VM's virtual hard disk drive 130.

In some embodiments, virtualization management module 144 may determine whether there is enough storage space available on the shared storage system as a precondition to the migration procedure. Virtualization management module 144 may proceed with the migration based on the shared storage system having an amount of available storage space that is equal to or greater than the amount of VM memory (e.g., vRAM 126) allocated for source VM 302. For example, if source VM 302 has 8 GB of vRAM, virtualization management module 144 will proceed with migrating the VM if there is at least 8 GB of available disk space in storage array 134.

Referring back to FIG. 2, at step 204, virtualization management module 144 instantiates a new VM on the destination host corresponding to the source VM. As shown in FIG. 3, the instantiated VM may be a placeholder virtual machine referred to as a “shadow” VM 304, which acts as a reservation for computing resources (e.g., CPU, memory) on the destination host, but does not communicate externally until shadow VM 304 takes over operations from source VM 302. In some implementations, the instantiated VM may be represented by one or more files stored within VM directory 308 and that contain configurations and metadata specifying a shadow VM corresponding to source VM 302. Shadow VM 304 may have the same VM-related configurations and settings as source VM 302, such as resource allocation settings (e.g., 4 GB of vRAM, two dual-core vCPUs), and network settings (e.g., IP address, subnet mask). In some embodiments, shadow VM 304 may be instantiated with the same configurations and settings as source VM 302 by copying or sharing the same VM-related configuration file (e.g., “.vmx” file) with source VM 302 stored in VM directory 308.

At step 206, source host 102₁ creates a file on the shared storage and locks the file. In the embodiment shown in FIG. 3, the source host creates a memory file 310 in VM directory 308 of datastore 138 and acquires a lock on memory file 310 that provides the source host with exclusive access to the file. At step 208, destination host 102₂ repeatedly attempts to obtain the lock on the created memory file. If the destination host is able to obtain a lock on memory file 310, the destination host proceeds to step 218, described below. Otherwise, the destination host may loop back to step 208 and keep trying to lock memory file 310.

At step 210, source host 102₁ copies source VM memory to memory file 310 in shared storage using storage interface 112 of source host 102₁ while source VM is in the powered-on state. For example, source host copies a plurality of memory pages from system memory 108 of the source host that represent the guest physical memory (e.g., vRAM 126) of source VM 302. In one or more embodiments, source host 102₁ copies out a plurality of memory pages from system memory 108 associated with source VM 302 using storage interface 112 and without copying any of the memory pages through NIC 110 to network 150.

In one or more embodiments, source host 102₁ may copy memory pages of source VM memory to memory file 310 in an iterative manner to allow source VM 302 to continue to run during the copying of VM memory. Hypervisor 114 on the source host may be configured to track changes to guest memory pages, for example, through traces placed on the guest memory pages. In some embodiments, at step 210, source host 102₁ may copy all of the memory pages of vRAM 126 into memory file 310 as an initial copy. As such, in contrast to the paging file for the VM (e.g., “.vmem” file), which may only contain a partial set of memory pages of guest memory during times of memory over commitment, VM memory file 310 contains the entire memory state of source VM 302. At step 212, hypervisor 114 of source host 102₁ determines whether guest physical memory pages have changed since a prior iteration of copying of source VM memory to the memory file, e.g., since copying vRAM 126 to memory file 310 began in step 210. If so, at step 214, the source host copies the memory pages that were modified since the prior copy was made to memory file 310 in shared storage. Copying the changed memory pages updates memory file 310 to reflect the latest guest memory of the source VM. In some embodiments, rather than simply having a log of memory page changes, the source host may update (i.e., overwrite) corresponding portions of memory file 310 based on the changed memory pages to reflect the current state of source VM 302. As such, data within memory file 310 can represent the execution state of source VM 302 in its entirety. Hypervisor 114 may repeatedly identify and copy changed memory pages to file 310 in an iterative process until no other changed memory pages are found. Otherwise, responsive to determining no more modified memory pages remain, the source host may proceed to step 216.

At step 216, the source host stuns source VM 302 and releases the lock on memory file 310 associated with the source host. In some embodiments, hypervisor 114 may momentarily quiesce source VM 302 during the switchover to the destination host to prevent further changes to the memory state of source VM 302. In some embodiments, hypervisor 114 may inject one or more halting instructions in the execution of source VM 302 to cause a delay during which a switchover to the destination may occur. It should be recognized that upon releasing the lock on memory file 310, destination host 102₂ may acquire the lock on memory file 310 as a result of repeatedly attempting to obtain a lock on the memory file (e.g., step 208).

At step 218, responsive to acquiring the lock on the memory file, destination host 102₂ gains access to VM memory file 310. In one or more embodiments, destination host 102₂ determines that the source VM is now ready to be live-migrated based on acquiring the lock and gaining access to VM memory file 310, and proceeds to step 222. At step 220, source host 102₁ transfers access to files 312 associated with source VM 302 from the source host to the destination host. As shown in FIG. 3, source host 102₁ may transfer access to files 312 within datastore 138, including the virtual machine disk file which stores data backing the virtual hard disk of source VM 302, log files, and other files associated with source VM 302.

At step 222, hypervisor 114 of destination host 102₂ resumes operation of shadow VM 304 and begins copying data from memory file 310 into destination VM memory (e.g., vRAM 306) associated with destination VM using the storage interface 112 of the destination host. At step 224, hypervisor 114 of destination host 102₂ detects whether a page fault has occurred during operation of shadow VM 304. If so, at step 226, responsive to a page fault for a memory page within shadow VM memory, hypervisor 114 of destination host 102₂ copies the memory page from VM memory file 310 in shared storage into vRAM 306 associated with shadow VM 304. In one or more embodiments, hypervisor 114 of destination host 102₂ copies VM memory data from VM memory file 310 responsive to a page fault without requesting the missing memory page from source host 102₁ over network 150. Otherwise, at step 228, hypervisor 114 of the destination host copies all remaining memory pages from VM memory file 310 in shared storage to the memory (e.g., system memory 108) of the destination host. In some embodiments where memory file 310 was updated “in-place” based on changed memory pages, destination host 102₂ may retrieve data for a given memory page in destination VM memory with a single copy from memory file 310, in contrast to embodiments where the memory file may be a log of memory page changes, which can require multiple copies and write operations to reach the latest state of VM memory.

At step 230, responsive to completing the migration, destination host 102₂ removes VM memory file 310 from datastore 138. At step 232, virtualization management module 144 removes source VM 302 from source host 102₁.

Accordingly, embodiments of the present disclosure provide a mechanism for migrating a VM from one host to another host without taxing network resources or requiring an additional dedicated network and the resultant additional hardware components, thereby reducing the hardware cost of the virtualized environment. While embodiments of the present disclosure describe transfer of the memory state of the source VM solely through shared storage, it should be recognized that other embodiments may perform memory transfer using shared storage in conjunction with—rather than instead of—an existing high-speed network connection to increase speed and performance during the migration. Such embodiments can be useful in virtualized environments that already have a dedicated network installed. In such embodiments, a portion of the memory state of the source VM may be transferred using shared storage, as described herein, and, in parallel, another portion of the memory state of the source VM may be transferred using the high-speed network. In some embodiments, the proportion of memory state transferred using shared storage or using the high-speed network may be dynamically determined in response to network traffic and available bandwidth at a given point in time. During periods of high network traffic from other applications or workloads executing on the source host, the source host may increase the proportion of memory state that is being transferred using shared storage. In one example, a virtualized computing system has a 1-Gbps network communicatively coupling hosts 102 and a shared storage system having a data transfer rate of 4-Gbps. When live migrating a virtual machine having 20 GBs of VM memory, 16 GB of VM memory may be transferred over the shared storage system, and the remaining 4 GB of VM memory may be transferred over the network.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

The various embodiments described herein may employ various computer-implemented operations involving data stored in computer systems. For example, these operations may require physical manipulation of physical quantities which usually, though not necessarily, take the form of electrical or magnetic signals where they, or representations of them, are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the description provided herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like. One or more embodiments of the present invention may be implemented as one or more computer programs or as one or more computer program modules embodied in one or more computer readable media. The term computer readable medium refers to any data storage device that can store data which can thereafter be input to a computer system; computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD-ROM (Compact Disc-ROM), a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claims(s).

What is claimed is:

1. A method for migrating a source virtual machine from a source host to a destination host, comprising:
instantiating a destination virtual machine (VM) on a destination host corresponding to a source VM on a source host;
creating a memory file stored in a shared storage system accessible by the source host and the destination host, wherein the source host has a lock on the memory file;
copying source VM memory to the memory file using a storage interface of the source host while the source VM is in a powered-on state;
acquiring, by operation of the destination host, the lock on the memory file;
responsive to acquiring the lock on the memory file, copying data from the memory file into destination VM memory associated with the destination VM using a storage interface of the destination host; and
transferring access for a virtual machine disk file associated with the source VM and stored in the shared storage system from the source host to the destination host.

2. The method of claim 1, wherein copying source VM memory to the memory file using the storage interface of the source host while the source VM is in the powered-on state further comprises:
copying a first plurality of memory pages from the source VM memory to the memory file;
iteratively copying a second plurality of memory pages from the source VM memory that were modified since performing a prior copy of source VM memory to the memory file; and
responsive to determining no modified memory pages remain, releasing, by operation of the source host, the lock on the memory file.

3. The method of claim 1, wherein the memory file comprises an entire memory state of the source VM.

4. The method of claim 1, further comprising:
resuming operation of the destination VM; and
removing the memory file from the shared storage system.

5. The method of claim 1, wherein copying data from the memory file into destination VM memory associated with the destination VM using the storage interface of the destination host further comprising:
responsive to a page fault for a memory page within the destination VM memory, copying, by operation of the destination host, the memory page from the memory file to the destination VM memory.

6. The method of claim 1, wherein the source VM memory is copied to the destination host without transferring any data over a network communicatively coupling the source host and the destination host.

7. The method of claim 1, wherein the storage interface of the source host comprises a FibreChannel host bus adapter connecting the source host to the shared storage system.

8. A non-transitory computer-readable storage medium comprising instructions that, when executed in a computing device, migrate a source virtual machine from a source host to a destination host, by performing the steps of:
instantiating a destination virtual machine (VM) on a destination host corresponding to a source VM on a source host;
creating a memory file stored in a shared storage system accessible by the source host and the destination host, wherein the source host has a lock on the memory file;
copying source VM memory to the memory file using a storage interface of the source host while the source VM is in a powered-on state;
acquiring, by operation of the destination host, the lock on the memory file;
responsive to acquiring the lock on the memory file, copying data from the memory file into destination VM memory associated with the destination VM using a storage interface of the destination host; and
transferring access for a virtual machine disk file associated with the source VM and stored in the shared storage system from the source host to the destination host.

9. The non-transitory computer-readable storage medium of claim 8, wherein the step of copying source VM memory to the memory file using the storage interface of the source host while the source VM is in the powered-on state further comprises:
copying a first plurality of memory pages from the source VM memory to the memory file;
iteratively copying a second plurality of memory pages from the source VM memory that were modified since performing a prior copy of source VM memory to the memory file; and
responsive to determining no modified memory pages remain, releasing, by operation of the source host, the lock on the memory file.

10. The non-transitory computer-readable storage medium of claim 8, wherein the memory file comprises an entire memory state of the source VM.

11. The non-transitory computer-readable storage medium of claim 8, wherein the instructions, when executed in the computing device, further perform the steps of:
resuming operation of the destination VM; and
removing the memory file from the shared storage system.

12. The non-transitory computer-readable storage medium of claim 8, wherein the step of copying data from the memory file into destination VM memory associated with the destination VM using the storage interface of the destination host further comprises:
responsive to a page fault for a memory page within the destination VM memory, copying, by operation of the destination host, the memory page from the memory file to the destination VM memory.

13. The non-transitory computer-readable storage medium of claim 8, wherein the source VM memory is copied to the destination host without transferring any data over a network communicatively coupling the source host and the destination host.

14. A computer system comprising:
a shared storage system storing one or more files associated with a source virtual machine (VM), wherein the one or more files includes a virtual machine disk file associated with the source VM;
a source host having a first storage interface connected to the shared storage system, wherein the source VM is executing on the source host; and
a destination host having a second storage interface connected to the shared storage system; and
a virtualization management module having a memory and a processor programmed to carry out the steps of:
instantiating a destination virtual machine (VM) on the destination host corresponding to the source VM on the source host;
creating a memory file stored in the shared storage system, wherein the source host has a lock on the memory file;
copying source VM memory to the memory file using the first storage interface while the source VM is in a powered-on state;
responsive to the destination host acquiring the lock on the memory file, copying data from the memory file into destination VM memory associated with the destination VM using the second storage interface; and
transferring access for the virtual machine disk file associated with the source VM from the source host to the destination host.

15. The computer system of claim 14, wherein the processor programmed to copy source VM memory to the memory file using the first storage interface while the source VM is in the powered-on state is further programmed to carry out the steps of:
copying a first plurality of memory pages from the source VM memory to the memory file;
iteratively copying a second plurality of memory pages from the source VM memory that were modified since performing a prior copy of source VM memory to the memory file; and
responsive to determining no modified memory pages remain, releasing the lock on the memory file by the source host.

16. The computer system of claim 14, wherein the memory file stored in the shared storage system comprises an entire memory state of the source VM.

17. The computer system of claim 14, wherein the processor is further programmed to carry out the steps of:
resuming operation of the destination VM; and
removing the memory file from the shared storage system.

18. The computer system of claim 14, wherein the processor programmed to copy data from the memory file into destination VM memory associated with the destination VM using the storage interface of the destination host is further programmed to carry out the steps of:
responsive to a page fault for a memory page within the destination VM memory, copying the memory page from the memory file to the destination VM memory in the destination host.

19. The computer system of claim 14, wherein the source VM memory is copied to the destination host without transferring any data over a network communicatively coupling the source host and the destination host.

20. The computer system of claim 14, wherein the first storage interface of the source host and the second storage interface of the destination host each comprise a FibreChannel host bus adapter connected to the shared storage system.
